(19) United States
(12) Patent Application Publication
(10) Pub. No.: US 2024/0085857 A1
(43) Pub. Date: Mar. 14, 2024

(54) SINGLE USE DISPOSABLE ELAPSED TIME INDICATOR WITH VOLATILE FLUID

(71) Applicant: CAREFUSION 303, INC., San Diego, CA (US)

(72) Inventors: Shwetha MAHADEV, Bangalore (IN); Shraya SAJJANAR, Dharwad (IN); Abin AUSTIN, Thrissur (IN)

(21) Appl. No.: 17/941,770

(22) Filed: Sep. 9, 2022

(51) Int. Cl. G04F 1/02

(52) U.S. Cl. CPC G04F 1/02

(57) ABSTRACT

A single use disposable elapsed time indicator and methods for using same can include an indicator having a chamber and a longitudinal channel for receiving a volatile fluid. A sponge is located and seated in the longitudinal channel and configured to allow evaporation of volatile fluid from within the longitudinal channel to an exterior of the longitudinal channel. A spring is included in the longitudinal channel which presses against an end of the chamber and against a plunger that is seated and moveable in the longitudinal channel along a longitudinal axis thereof. The spring is configured to exert force on and move the plunger from a first end of the chamber toward a second end of the chamber along the longitudinal axis in the longitudinal channel as volatile fluid in the longitudinal channel evaporates through the sponge. The movement of the plunger thereby marks elapsed time along a graded scale.

### TECHNICAL FIELD

The present disclosure generally relates to single use disposable elapsed time indicators and more particularly to an elapsed time indicating device that can be used with medical devices that operates based on evaporation of a volatile fluid from within the indicator.

### BACKGROUND

Many medical devices have a limited shelf-life and are designed for use over a limited period of time once the device is placed in service. Such products are usually associated with a single event, a restricted time period or restricted access. For example, nearly all modern medical device disposables such as syringes, needless access connectors, needle-free connectors (NFCs), catheters, have a desired time limit for use once the device is placed in service or activated.

In some instances, a healthcare professional charts or notates a start time when a device is placed in service. However, this is not always the case. And often times, the length of time that a device is placed in service is not known.

Disposable time indicating devices are also known. See U.S. Pat. Nos. 3,954,011 and 5,602,804 and 8,388,131.

However, a continuing need exists for disposable elapsed time indicators that can be used in medical environment and particularly elapsed indicating devices that can show the time period that has elapsed and time period remaining so as to provide the healthcare professional sufficient time to make preparations regarding the particular device being monitored.

### SUMMARY OF THE DISCLOSURE

Aspects of the subject technology relate to a single use disposable elapsed time indicator that that includes a spring configured to exert force on and move a plunger along a longitudinal channel as volatile fluid evaporates from the longitudinal channel over a predetermined time. The longitudinal channel can also include a graded scale. The movement of the plunger due to evaporation of the volatile fluid advantageously thereby marks elapsed time the along the graded scale. Such an indicator can comprise a chamber having a first end and a second end opposing the first end, and a longitudinal channel between the first and second end for receiving a volatile fluid. A sponge is located at the second end of the chamber and seated in the longitudinal channel. Such a sponge is configured to allow evaporation of volatile fluid from within the longitudinal channel to an exterior of the chamber, e.g., to the exterior atmosphere. A spring is included in the longitudinal channel. The spring has a first end and a second end opposing the first end, wherein the first end of the spring presses against the first end of the chamber and the second end of the spring presses against a plunger that is seated and moveable in the longitudinal channel along a longitudinal axis (X). A graded scale is provided along the longitudinal axis of the longitudinal channel to indicate periods of elapsed time. The spring is configured to exert force on and move the plunger from the first end of the chamber toward the second end of the chamber along the longitudinal axis in the longitudinal channel as volatile fluid in the longitudinal channel evaporates through the sponge and thereby mark elapsed time on the graded scale.

Additional aspects of the subject technology include methods of using single use disposable elapsed time indicator. Such methods can comprise an indicator that includes a spring configured to exert force on and move a plunger along a longitudinal channel as volatile fluid evaporates from the longitudinal channel over a predetermined time and includes activating the indicator by exposing the volatile fluid to an exterior of the longitudinal channel. Such exposure can be carried out by removing a covering seal on an end of the longitudinal channel.

Embodiments of the foregoing include one or more of the following features individually or combined. For example, the volatile fluid can comprise an alcohol, e.g., isopropanol and/or ethanol, ether, glycol, etc. or other such volatile fluids used in the medical field.

Additional advantages of the subject technology will become readily apparent to those skilled in this art from the following detailed description, wherein only certain aspects of the subject technology are shown and described, simply by way of illustration. As will be realized, the subject technology is capable of other and different configurations, and its several details are capable of modifications in various other respects, all without departing from the subject technology. Accordingly, the drawings and description are to be regarded as illustrative in nature, and not as restrictive.

### BRIEF DESCRIPTION OF THE DRAWINGS

The accompanying drawing, which is included to provide further understanding and is incorporated in and constitute a part of this specification, illustrate disclosed embodiments and together with the description serve to explain the principles of the disclosed embodiments. In the drawings:

FIG. 1 depicts a single use disposable elapsed time indicating device according to aspects of the present disclosure.

FIG. 2 is another view of the single use disposable elapsed time indicating device of FIG. 1.

FIG. 3 is a sectional view of the single use disposable elapsed time indicating device of FIG. 1.

FIGS. 4A and 4B illustrate an exploded view of the single use disposable elapsed time indicating device of FIG. 1.

FIGS. 5A, 5B, 5C and 5D illustrate an operation of using a single use disposable elapsed time indicator according to aspects of the present disclosure

FIGS. 6A and 6B show a single use disposable elapsed time indicating device in an initial state and in an expired state, respectively.

FIG. 7 illustrates a method of using a single use disposable elapsed time indicating device according to aspects of the present disclosure.

### DETAILED DESCRIPTION OF THE DISCLOSURE

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions are provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the appended claims. Various aspects of the subject technology will now be disclosed according to particular but non-limiting examples. Various embodiments described in the present disclosure may be carried out in different ways and variations, and in accordance with a desired application or implementation.

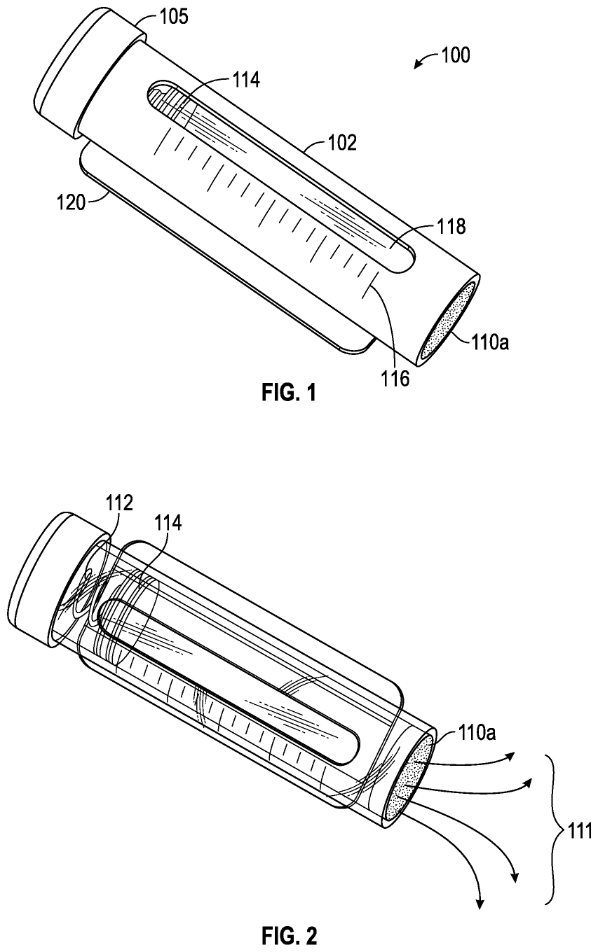

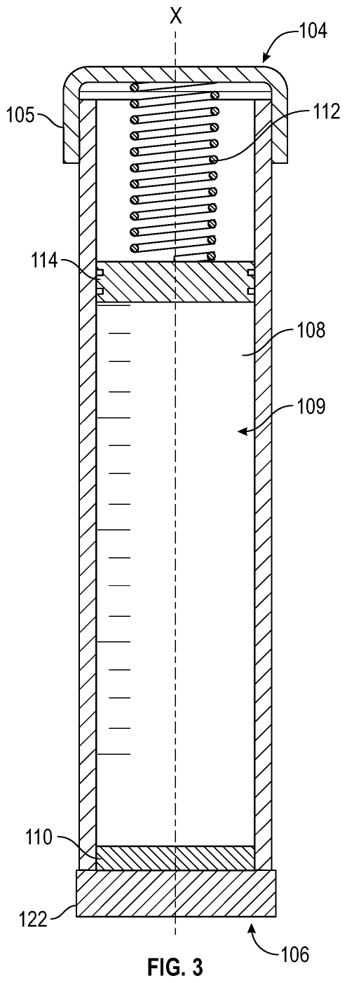

Referring now in more detail to the drawings in which like reference numerals refer to like or corresponding elements among the several views, there is shown in FIGS. 1, 2, 3 and 4, a single use disposable elapsed time indicator according to aspects of the present disclosure (100). As illustrated, the indicator includes a chamber 102 having a first end 104 and a second end 106, which opposed the first end 104. The chamber also includes a longitudinal channel 108 between the first end 104 and the second end 106 along a longitudinal axis (X). For this example, chamber 102 is a cylinder having a first opening at the first end 104 and a second opening at the second end 106. The longitudinal channel 108 can receive a volatile fluid such as a fluid comprised of an alcohol, ether, glycol, etc. or other such volatile fluids used in the medical field.

A sponge 110 is located at the second end 106 of the chamber 102 and seated in the longitudinal channel 108. The sponge presents an evaporative barrier between a volatile fluid within the longitudinal channel and the exterior of the longitudinal channel (e.g., the external environment). The sponge has an external surface exterior surface 110a that is exposed to an exterior of the chamber to allow evaporation of the fluid from the chamber. The sponge can also include a removeable covering seal 122 on its exterior surface 110a to prevent evaporation of the fluid until the indicator is activated by removal of the covering seal 122.

In practicing aspects of the present disclosure, the sponge is configured to allow evaporation of a volatile fluid from within the longitudinal channel to an exterior of the chamber. In some embodiments, the sponge can be of a composition that it wicks the fluid from the longitudinal channel to an exterior surface 110a of the sponge 110 to facilitate evaporation of the volatile fluid (111) from the exterior sponge surface 110a. The sponge can be made of a polyolefin such as polypropylene with embedded cellulose fibers for wicking fluid to an exterior surface of the sponge, a cellulose sponge, etc.

To facilitate evaporation of the fluid and to mark elapsed time, a spring is included in the indicator with a plunger to exert pressure on the fluid in the longitudinal channel along the longitudinal axis and allow the device to effectively operate when oriented at any angle or even when upside down (e.g., the exterior surface 110a of the sponge 110 is oriented upward away from the ground). As shown in the aspect of FIGS. 1-4, a spring 112 having a first end 112a and a second end 112b opposing the first end is included in the longitudinal channel 108. The first end 112a of the spring 112 presses against the first end 104 of the chamber and the second opposing end of the spring presses against a plunger 114 that is seated and moveable in the longitudinal channel 108 along the longitudinal axis.

The spring is configured to exert force on and move the plunger from the first end of the chamber toward the opposing second end of the chamber along the longitudinal axis in the longitudinal channel. The spring can be composed of a plastic or metal. The plunger moves from the first end of the chamber toward the opposing second end of the chamber along the longitudinal axis in the longitudinal channel as volatile fluid in the longitudinal channel evaporates through the sponge over a predetermined time. The plunger can be composed of a rubber such as a silicone rubber, a nitrile rubber such as nitrile-butadiene rubber (NBR).

As shown in this example, first end 112a of spring 112 presses against a cap 105 that covers the first end 104 of the chamber 102. The cap can be a snap-on cap or a screw cap to cover the first end of the chamber. The first end of the spring can be connected to the cap or simply unfastened when pressed against the cap. Separately, the second end 112b of the spring 112 can be connected to the plunger 114 or simply unfastened when pressed against the plunger. Using a cap readily allows easy assembly and sealing of the longitudinal channel once filled with the volatile fluid.

The indicator also includes a graded scale 116 along the longitudinal axis of the longitudinal channel to indicate periods of elapsed time. The graded scale has markings to denote elapsed time periods such as markings for elapsed periods of hours or days, for example. The marking can be in the form of ticks or lines together with numbers, words, symbols and disposed on a surface of the chamber along the viewing window. Thus, the associated elapsed time period can be indicated by markings, such as ticks with word descriptions of the time period (e.g., hour 1, hour 2, etc., day 1, day 2, day 3, day 4, etc.) or simply numbers by themselves (e.g., 1, 2, 3, 4, etc.).

If the chamber or longitudinal channel is not composed of a transparent or translucent material, e.g., a polycarbonate, the chamber can also include a viewing window 118 along the longitudinal axis (X) of the longitudinal channel 108. Alternatively, the chamber and longitudinal channel can be composed of a transparent material and partially enclosed by an outer shell wherein the viewing window is formed by a slot in the outer shell. The viewing window 118 is configured so than the plunger can be observed together with the graded scale so that elapsed time can be determined as fluid evaporates from the longitudinal channel. The chamber and longitudinal channel can be individually composed of one or more of a plastic, polycarbonate, polyacrylate, polyester, polyolefin such as polypropylene acrylonitrile-butadiene-styrene copolymer, etc. The viewing window can be composed of a glass or transparent plastic.

As noted above, the spring is configured to exert force on and move the plunger from the first end of the chamber toward the second end of the chamber along the longitudinal axis in the longitudinal channel. As the volatile fluid in the longitudinal channel evaporates through the sponge, the plunger moves at a predetermined rate which is used to graduate the scale in hours and/or days. Thus, the various makings of the graded scale can be used to track elapsed time as the plunger aligns with, approaches or crosses the markings. The various makings of the graded scale can also be used to estimate the remaining time before a given device expires.

In aspects of the disclosure, sample evaporation calculations can be estimated based on the evaporation of water and then applied to the particular fluid used in the longitudinal channel of the indicator device of the present disclosure. For example, the amount of evaporated water liquid can be expressed as gₕ=Θ A (xₛ−x), where gh=amount of evaporated water per hour (kg/h), Θ=(25+19 v)=evaporation coefficient (kg/m2h), v=velocity of air above the water surface (m/s), A=water surface area (m2), xₛ=maximum humidity ratio of saturated air at the same temperature as the water surface (kg/kg) (kg H₂O in kg Dry Air)—constant in specific area, and x=air humidity ratio (kg/kg) (kg H₂O in kg Dry Air). Based on similar calculations for the volatile fluid, elapsed time can be estimated from the activation of the indicator.

Volatile fluids that can be used with indicator devices according to aspects of the present disclosure include, for example, an alcohol, such as isopropanol, ethanol, an ether, a glycol ether, a hand sanitizer formulation such as those that include 50-75% of an alcohol such as ethanol, or other such volatile fluids used in the medical field. Alcoholic formulations including 50% to 100%, such as 70%-100 by volume of the alcohol, e.g., isopropanol, ethanol, are useful volatile fluids.

Indicator devices according to aspects of the present disclosure can also include a wing (120) or flat plate like extrusion from the chamber. Such wings can be used to label and identify the indicator. Indicator devices according to aspects of the present disclosure can also a fastener to secure the indicator to a medical device. For example, the wing can also include a hole (not shown) through which a line or string can be passed and used to fasten the indicator to a particular medical device to track elapsed time. Alternatively, or in combination with a string or line, indicator devices according to aspects of the present disclosure can also include an adhesive, such as a peel-off sticker, on a surface of the indicator to adhere the indicator to a medical device.

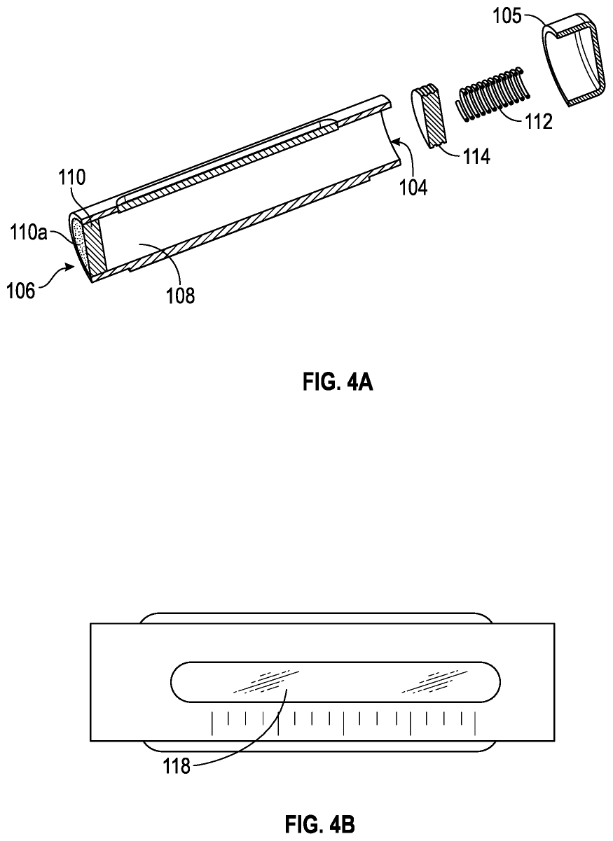

The indicator of the example shown in FIG. 4A-4B can be readily assembled by seating a sponge 110 in the second end of the longitudinal channel followed by adding a volatile fluid in the longitudinal channel 108. The plunger 114, spring 112 and a cap 105 can then be assembled over the first end of the longitudinal channel. Advantageously, single use disposable elapsed time indicators according to aspects of the present disclosure can be sterilized. That is the indicators can be subjected to radiation or heat sufficient to sterilize the device.

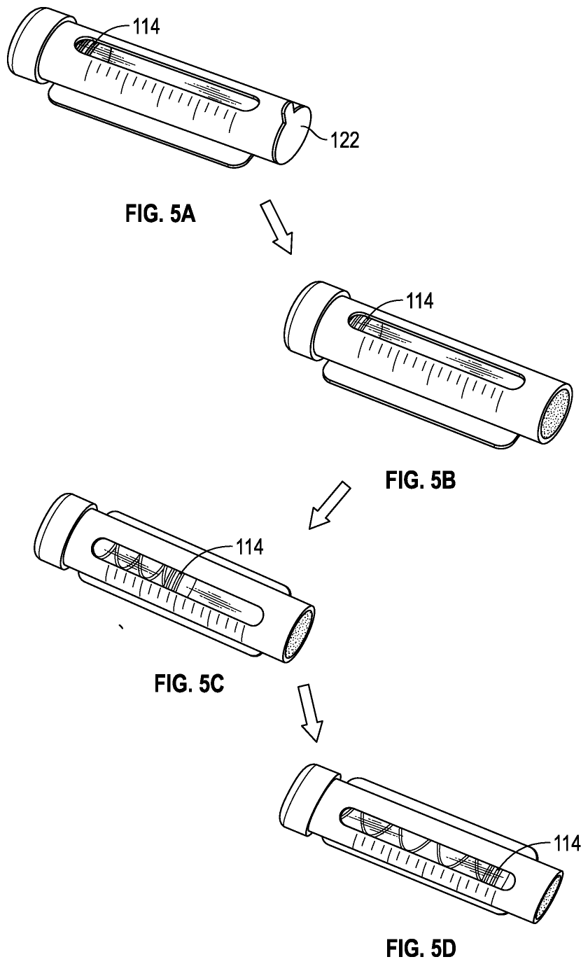

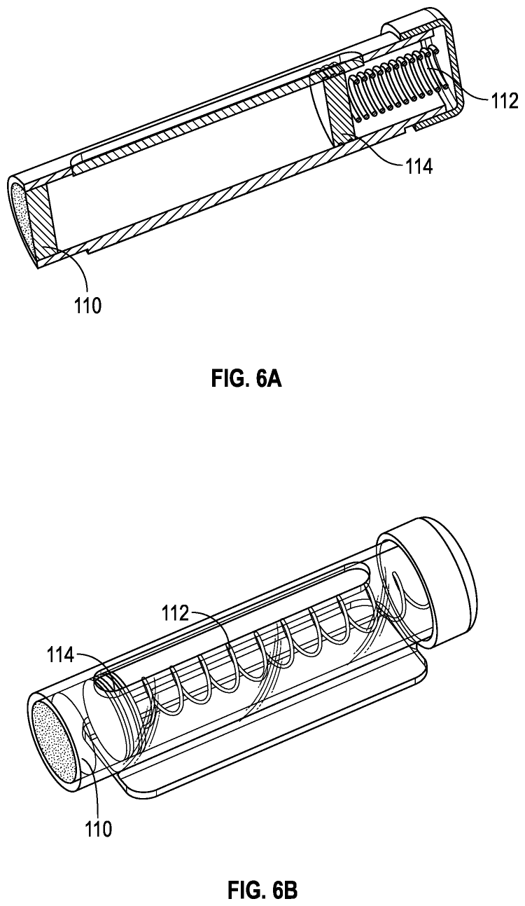

FIGS. 5A-5D and 6A-6B illustrate an operation of using a single use disposable elapsed time indicator according to aspects of the present disclosure. As shown in the packed state in FIG. 5A, the plunger is nearest the first end of the longitudinal channel with the spring being most compressed. Upon removal of the covering seal 122, the indicator is activated and evaporation of the fluid within the longitudinal channel begins. The rate of evaporation of the volatile fluid in the channel is a function of time and depends, in part, on the nature of the fluid, the sponge and the volume of the fluid. During evaporation of the volatile fluid, the spring moves the plunger toward the second end of the longitudinal channel. FIGS. 5B though 5D show the plunger at various times after removal of the covering seal. For example, FIG. 5C shows the plunger at half of the elapsed time period and FIG. 5D shows the plunger at a final expiration elapsed time period.

As another example, FIGS. 6A and 6B show a single use disposable elapsed time indicating device in an initial state and in an expired state, respectively. As shown in FIG. 6A, the spring 112, is compressed and plunger 114 is nearest the first end 140 of the longitudinal channel. Upon activation of the indicator, e.g., removal of a covering seal over the sponge, the plunger starts to move slowly toward the second end of the longitudinal channel as a function of time due to evaporation of the volatile fluid in the channel. As shown in FIG. 6B, when the indicator is expired, the spring moved the plunger to its final position nearest the second, opposing end of the longitudinal channel. At such final position, the indicator alters the healthcare professional to take action needed at the expiration of elapsed time such as to clean or replace the particular medical device.

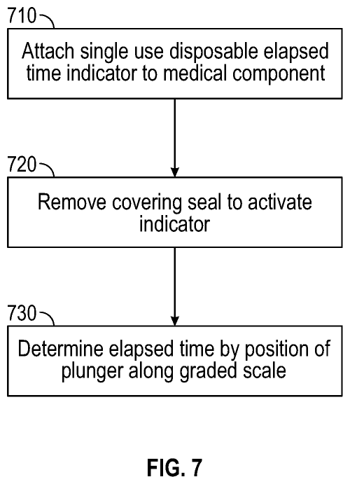

Additional aspects of the subject technology include methods of using single use disposable elapsed time indicator. Such methods can comprise an indicator that includes a spring configured to exert force on and move a plunger along a longitudinal channel as volatile fluid evaporates from the longitudinal channel over a predetermined time and includes activating the indicator by exposing the volatile fluid to an exterior of the longitudinal channel. Such exposure can be carried out by removing a cover seal on an end of the longitudinal channel to expose the volatile fluid to the atmosphere, for example. FIG. 7 illustrates an exemplary method of using a single use disposable elapsed time indicator according to aspects of the present disclosure. In step 710, an indicator (e.g., a single use disposable elapsed time indicator 100) is fastened to a medical component (e.g., needleless connector, Intravenous sets, Urinary bags, secondary sets, Oncology sets etc. In aspects of the disclosure, the indicator can be fastened to the medical device by an adhesive or string, etc.

Indicators according to the present disclosure can be activated by removing a covering seal from on an end of the longitudinal channel, such as by removing a covering seal (e.g., covering seal 122) to activate the indicator in step 720. For example, a covering seal (e.g., covering seal 122) can be peeled off or removed from an exterior surface 110a of sponge 110 to expose a volatile fluid in the longitudinal channel 108 to the external atmosphere.

In step 730, a determination of elapsed time from activation of the indicator is determined by observing the position of the plunger along the graded scale. For example, as the volume of the volatile fluid in the longitudinal channel is reduced due to evaporation of the fluid to the exterior of the channel, e.g., to the atmosphere, the plunger moves toward the second end of the longitudinal channel at a predetermined rate. Markings along the longitudinal channel indicate the elapsed time at different marks and noting the location of the plunger along the graded scale indicates the elapsed time thus providing visual references of elapsed times associated with the level of fluid remaining at any given time after activation.

### EXAMPLES

The following examples are intended to further illustrate certain preferred embodiments of the invention and are not limiting in nature. Those skilled in the art will recognize, or be able to ascertain, using no more than routine experimentation, numerous equivalents to the specific substances and procedures described herein.

An experiment was performed in which isopropyl alcohol was added to an open tube and hand sanitizer gel was added in a separate open tube. The volumes of the liquids were recorded over a period of several days. It was observed that there was a reduction in the volume of each liquid on a daily basis in nearly a linear fashion, which demonstrated that such liquids can be used as volatile fluids in single use disposable elapsed time indicators according to the present disclosure.

It is understood that any specific order or hierarchy of blocks in the methods of processes disclosed is an illustration of example approaches. Based upon design or implementation preferences, it is understood that the specific order or hierarchy of blocks in the processes may be rearranged, or that all illustrated blocks be performed. In some implementations, any of the blocks may be performed simultaneously.

The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

The word “exemplary” is used herein to mean “serving as an example or illustration.” Any aspect or design described herein as “exemplary” is not necessarily to be construed as preferred or advantageous over other aspects or designs. In one aspect, various alternative configurations and operations described herein may be considered to be at least equivalent.

As used herein, the phrase “at least one of” preceding a series of items, with the term “or” to separate any of the items, modifies the list as a whole, rather than each item of the list. The phrase “at least one of” does not require selection of at least one item; rather, the phrase allows a meaning that includes at least one of any one of the items, and/or at least one of any combination of the items, and/or at least one of each of the items. By way of example, the phrase “at least one of A, B, or C” may refer to: only A, only B, or only C; or any combination of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain.

It is understood that the specific order or hierarchy of steps, operations or processes disclosed is an illustration of exemplary approaches. Based upon design preferences, it is understood that the specific order or hierarchy of steps, operations or processes may be rearranged. Some of the steps, operations or processes may be performed simultaneously. Some or all of the steps, operations, or processes may be performed automatically, without the intervention of a user. The accompanying method claims, if any, present elements of the various steps, operations or processes in a sample order, and are not meant to be limited to the specific order or hierarchy presented.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.” Furthermore, to the extent that the term “include,” “have,” or the like is used, such term is intended to be inclusive in a manner similar to the term “comprise” as “comprise” is interpreted when employed as a transitional word in a claim.

The Title, Background, Summary, Brief Description of the Drawings and Abstract of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the Detailed Description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirement of 35 U.S.C. § 101, 102, or 103, nor should they be interpreted in such a way.

What is claimed is:

1. A single use disposable elapsed time indicator comprising:
a chamber having a first end and a second end opposing the first end, and a longitudinal channel between the first and second end for receiving a volatile fluid;
a sponge located at the second end of the chamber and seated in the longitudinal channel, wherein the sponge is configured to allow evaporation of volatile fluid from within the longitudinal channel to an exterior of the chamber;
a spring included in the longitudinal channel having a first end and a second end opposing the first end, wherein the first end of the spring presses against the first end of the chamber and the second end of the spring presses against a plunger that is seated and moveable in the longitudinal channel along a longitudinal axis thereof; and
a graded scale along the longitudinal axis of the longitudinal channel to indicate periods of elapsed time;
wherein the spring is configured to exert force on and move the plunger from the first end of the chamber toward the second end of the chamber along the longitudinal axis in the longitudinal channel as volatile fluid evaporates from the longitudinal channel evaporates through the sponge and thereby mark elapsed time on the graded scale.

2. The indicator of claim 1, wherein the chamber has a viewing window along the longitudinal channel for viewing the plunger.

3. The indicator of claim 1, further comprising a covering seal over the sponge to prevent evaporation of a volatile fluid in the chamber.

4. The indicator of claim 1, further comprising a fastener to secure the indicator to a medical device.

5. The indicator of claim 1, further comprising an adhesive on a surface of the indicator to adhere the indicator to a medical device.

6. The indicator of claim 1, wherein the graded scale denotes elapsed time periods of hours or days.

7. The indicator of claim 1, wherein the first end of the chamber is covered by a cap and wherein the first end of the spring presses against the cap.

8. The indicator of claim 1, further comprising a volatile fluid in the longitudinal chamber.

9. The indicator of claim 8, wherein the volatile fluid comprises isopropanol and/or ethanol.

11. The indicator of claim 1, further comprising a wing.

12. The indicator of claim 1, wherein the indicator is sterilized.

13. The indicator of claim 1, wherein the plunger is composed of a rubber.

14. The indicator of claim 1, wherein the chamber and longitudinal channel are composed of a plastic.

15. The indicator of claim 1, wherein the chamber and longitudinal channel are composed of one or more of a polycarbonate, polyolefin or acrylonitrile-butadiene-styrene copolymer.

16. The indicator of claim 1, wherein the chamber is in the form of a cylinder having a first opening at the first end and a second opening at the second end.

17. A method of using single use disposable elapsed time indicator that includes a spring configured to exert force on and move a plunger along a longitudinal channel as volatile fluid evaporates from the longitudinal channel over a predetermined time, the method comprising:
activating the indicator by exposing the volatile fluid to an exterior of the longitudinal channel.

18. The method of claim 17, further comprising fastening the indicator to a medical device.

19. The method of claim 18, wherein the medical device is a needleless connector, Intravenous sets, Urinary bags.

20. The method of claim 17, wherein activating the device includes removing a covering seal on an end of the longitudinal channel.
